(19) United States
(12) Patent Application Publication
(10) Pub. No.: US 2026/0086699 A1
(43) Pub. Date: Mar. 26, 2026

(54) EFFECT PROCESSING METHOD ELECTRONIC DEVICE, AND STORAGE MEDIUM

(71) Applicant: Beijing Zitiao Network Technology Co., Ltd., Beijing (CN)

(72) Inventors: Zengzhi FAN, Beijing (CN); Dongbao YAN, Beijing (CN); Zhe LI, Beijing (CN)

(21) Appl. No.: 19/333,960

(22) Filed: Sep. 19, 2025

(30) Foreign Application Priority Data
Sep. 20, 2024 (CN) 202411320593.X

(51) Int. Cl. G06F 3/0484; G06F 9/48

(52) U.S. Cl. CPC G06F 3/0484; G06F 9/4881

(57) ABSTRACT

Embodiments of the present disclosure provide an effect processing method, an electronic device, and a storage medium. The method includes: obtaining effect input information and a target effect file in response to an effect processing request entered on a client, wherein the target effect file includes at least one effect processing component and a component scheduling file, the component scheduling file includes a component scheduling logic for scheduling the effect processing component; and processing the effect input information by the component scheduling file and the effect processing component, to obtain target effect information corresponding to the effect input information, and displaying the target effect information on the client.

### CROSS-REFERENCE TO RELATED APPLICATION

This application claims the priority to and benefits of the Chinese Patent Application, No. 202411320593.X, which was filed on Sep. 20, 2024. The aforementioned patent application is hereby incorporated by reference in its entirety.

### TECHNICAL FIELD

Embodiments of the present disclosure relate to an effect processing method, an electronic device, and a storage medium.

### BACKGROUND

With the development of computer vision technology, more and more users apply a series of effects in information processing to enrich the display effect of information. In the related art, a series of complex logic codes of effect processing are typically written in an effect file in turn, which have a large amount of codes, poor readability and inconvenience for subsequent maintenance of the effect file.

### SUMMARY

The present disclosure provides an effect processing method, an apparatus, an electronic device, a storage medium and a program product, which realize the componentization of an effect file in the effect processing, and improve the readability and maintainability of codes in the effect file.

According to a first aspect, an embodiment of the present disclosure provides an effect processing method, the method including: obtaining effect input information and a target effect file in response to an effect processing request entered on a client, wherein the target effect file includes at least one effect processing component and a component scheduling file, the component scheduling file includes a component scheduling logic for scheduling the effect processing component; and

processing the effect input information by the component scheduling file and the effect processing component, to obtain target effect information corresponding to the effect input information, and displaying the target effect information on the client.

In a second aspect, an embodiment of the present disclosure further provides an effect processing apparatus, including:
an effect processing request module, configured to obtain effect input information and a target effect file in response to an effect processing request entered on a client, wherein the target effect file includes at least one effect processing component and a component scheduling file, the component scheduling file includes a component scheduling logic for scheduling the effect processing component; and
a target effect display module, configured to process the effect input information by the component scheduling file and the effect processing component, to obtain target effect information corresponding to the effect input information, and displaying the target effect information on the client.

In a third aspect, an embodiment of the present disclosure further provides an electronic device, including:
one or more processors; and
a storage apparatus for storing one or more programs,
wherein the one or more programs, when executed by the one or more processors, cause the one or more processors to implement the effect processing method of any one of the embodiments of the present disclosure.

In a fourth aspect, an embodiment of the present disclosure also provides a storage medium including computer-executable instructions wherein the computer-executable instructions, when executed by a computer processor, cause the computer processor to perform the effect processing method of any of the embodiments of the present.

According to a fifth aspect, an embodiment of the present disclosure further provides a computer program product including a computer program, wherein, when executed by a processer, cause the processor to perform the effect processing method of any of the embodiments of the present.

### BRIEF DESCRIPTION OF DRAWINGS

The above and other features, advantages and aspects of the embodiments of the present disclosure will become more apparent when taken in conjunction with the drawings and with reference to the following detailed description of embodiments. Throughout the drawings, the same or similar reference numerals refer to the same or similar elements. It should be understood that the drawings are schematic and that parts and elements are not necessarily drawn to scale.

FIG. 1 is a schematic flow diagram of an effect processing method according to an embodiment of the present disclosure.

FIG. 2 is a schematic flow diagram of another effect processing method provided by an embodiment of the present disclosure.

FIG. 3 is a schematic flow diagram of another effect processing method according to an embodiment of the present disclosure.

FIG. 4 is a schematic flow diagram of another effect processing method according to an embodiment of the present disclosure.

FIG. 5 is a schematic flow diagram of another effect processing method according to an embodiment of the present disclosure.

FIG. 6 is an example diagram of a target effect file provided by an embodiment of the present disclosure.

FIG. 7 is an example diagram of effect processing to which an effect processing method being applied, provided by an embodiment of the present disclosure.

FIG. 8 is an is an example diagram of effect processing to which an effect processing method being applied, provided by an embodiment of the present disclosure.

FIG. 9 is a schematic structural diagram of an effect processing apparatus according to an embodiment of the present disclosure.

FIG. 10 is a schematic structural diagram of an electronic device according to an embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms, and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders and/or in parallel. In addition, the method implementations may include additional steps and/or omit performing the illustrated steps. The scope of the present disclosure is not limited in this respect.

As used herein, the term “include” and its variants are open-ended inclusions, that is, “include but not limited to”. The term “based on” is “based at least in part on”. The term “an embodiment” represents “at least one embodiment”; the term “another embodiment” represents “at least one other embodiment”; the term “some embodiments” represents “at least some embodiments”. Relevant definitions of other terms will be given in the description below.

It should be noted that the concepts such as “first” and “second” mentioned in the present disclosure are only used to distinguish different apparatuses, modules or units, and are not used to limit the order or interdependence of the functions performed by these apparatuses, modules or units.

It should be noted that the modifications of “one” and “a plurality of” mentioned in the present disclosure are illustrative rather than restrictive, and those skilled in the art should understand that unless the context clearly indicates otherwise, they should be understood as “one or more”.

The names of messages or information exchanged between multiple apparatuses in the implementations of the present disclosure are only used for illustrative purposes, and are not used to limit the scope of these messages or information.

It may be understood that before using the technical solution disclosed in the embodiments of the present disclosure, the user should be informed of the type, scope of use, usage scenario, etc. of the personal information involved in the present disclosure in an appropriate manner according to relevant laws and regulations, and the user's authorization should be obtained.

For example, in response to receiving an active request from the user, prompt information is sent to the user to explicitly prompt the user that the operation requested to be performed will require the acquisition and use of the user's personal information. Thus, the user can independently select whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It may be understood that the above process of notifying and obtaining the user's authorization is only illustrative, and does not constitute a limitation on the implementations of the present disclosure. Other manners that meet relevant laws and regulations may also be applied to the implementations of the present disclosure.

At the same time, it may be understood that the data involved in the technical solution (including but not limited to the data itself, the acquisition or use of the data) should comply with the requirements of corresponding laws, regulations and related provisions.

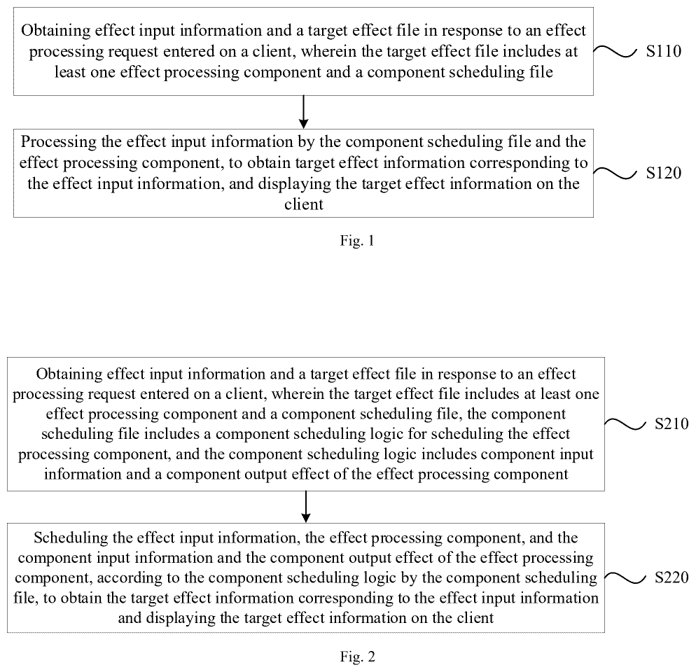

FIG. 1 is a schematic flow diagram of an effect processing method provided by an embodiment of the present disclosure, and the embodiment of the present disclosure is applicable to a situation where effect processing is performed on effect input information. The method may be executed by an effect processing apparatus, and the apparatus may be implemented in the form of software and/or hardware. Optionally the apparatus can be implemented by an electronic device, which may be a mobile terminal, a PC, a server, or the like. As shown in FIG. 1, the method of the present embodiment may specifically include:

S110, obtaining effect input information and a target effect file in response to an effect processing request entered on a client, wherein the target effect file includes at least one effect processing component and a component scheduling file.

The effect processing request can be understood as a request for performing effect processing on effect input information. The effect processing request may record effect input information and effect performance information corresponding to the effect input information. The effect input information may be image information and/or text information carried in the effect processing request, and the text information may be prompt information of a content generation model. The effect performance information can be understood as performance information of effect display of the effect input information. The effect performance information may be used to determine a target effect file. The target effect file can be understood as an effect file that needs effect processing on the effect input information.

In an embodiment of the present disclosure, the target effect file may include the at least one effect processing component and the component scheduling file. The component scheduling file may include component scheduling logic for scheduling the effect processing component. The effect processing component may be a component obtained by performing componentization processing on the target effect file. Alternatively, the effect processing component may be a component obtained by division of target effect file according to execution body (e.g., a client or a cloud). In the embodiment of the present disclosure, the target effect file is componentized to the effect processing component, and component division with high cohesion and low coupling for the target effect file is realized, thereby improving the reusability and portability of the effect component code. Optionally, the effect processing component may include at least one selected from a group consisting of a client processing component and a cloud processing component. The client processing component can be understood as an effect processing component that needs to run in the client. The cloud processing component can be understood as an effect processing component that needs to run in the cloud.

In an embodiment of the present disclosure, the cloud processing component may describe a cloud processing flow to be executed in a target cloud. The target cloud may be understood as a cloud on which the cloud processing component runs. A file format of the cloud processing flow may be a JavaScript Object Notation (JSON) format. In the embodiment of the present disclosure, the cloud processing flow is written in a JSON format, and the readability of the cloud processing flow can be improved. The cloud processing flow may include at least one cloud processing node. The at least one cloud processing node corresponds to at least one effect processing operation. In an embodiment of the present disclosure, when a number of cloud processing nodes included in the cloud processing flow is multiple, in order to improve a processing efficiency of the cloud component, effect processing operations corresponding to cloud processing nodes without dependency relationship may be executed in parallel. Optionally, a input parameter of an effect processing operation corresponding to a cloud processing node may be configured by a placeholder. In an embodiment of the present disclosure, a placeholder parameter that may be included in the placeholder can be set according to actual needs, for example, video, picture, and text. Similarly, the type of the placeholder parameter can also be set according to actual needs, such as an array type, a dictionary, and the like. The advantage is that the input parameter of the effect processing operation corresponding to the cloud processing node can be dynamically changed, thereby improving the reusability of the cloud processing node.

Specifically, after receiving the effect processing request input by the client, the effect input information and the effect performance information corresponding to the effect input information may be determined based on the effect processing request. Further, the effect processing component and the component scheduling file corresponding to the effect performance information may be determined based on the effect performance information. Then, an effect file including the effect processing component and the component scheduling file can be determined, and the effect file including the effect processing component and the component scheduling file can be determined as a target effect file.

In an embodiment of the present disclosure, after obtaining the target effect file, the step may further include: receiving a field editing operation for a target field in a predefined field injection function, wherein the field injection function includes a node identifier corresponding to the cloud processing node; and injecting the target field, which is edited, in the field injection function into a node code of the cloud processing node corresponding to the node identifier.

The field injection function which being predefined, can be understood as used for injecting of the target field into the node code of the cloud processing node. The field injection function may include a node identifier corresponding to the cloud processing node. The node identifier may be used to distinguish different cloud processing nodes. The target field can be understood as a field that needs to be injected into the node code of the cloud processing node. The field editing operation can be understood as an operation for editing the target field in the field injection function.

In an embodiment of the present disclosure, an edited field injection function may be obtained after receiving the edit operation field for the target field in the predefined field injection function. Further, by executing the edited field injection function, an edited target field in the field injection function may be injected into the node code of the cloud processing node corresponding to the node identifier. Specifically, the node identifier, which corresponds to the cloud processing node, in the field injection function may be determined first. Then, the target field, which is edited, in the field injection function may be injected into the node code of the cloud processing node corresponding to the node identifier.

In the embodiment of the present disclosure, there is a case that the node code may include the edited target field, that is, a field in the node code and the edited target field may have a duplicate field. Exemplarily, the edited target field may include a first field and a second field, and the first field may be included in the node code. Based on this, injecting the edited target field in the field injection function into the node code of the cloud processing node corresponding to the node identifier, is specifically implemented, by executing the field injection function, a field value of the first field in the node code may be replaced with a field value of a first field in the edited target field, and a second field in the edited target field and a field value corresponding to the second field may be added to the node code.

In an embodiment of the present disclosure, after obtaining the target effect file, the method further includes: in response to a component multiplexing operation for the effect processing component in the target effect file, determining a target multiplexing location for the effect processing component based on the component multiplexing operation, and adding the effect processing component to the target multiplexing location. The effect processing component may be added to the target multiplexing location. The component multiplexing operation can be understood as an operation for multiplexing the effect processing component in the target effect file. Optionally, the component multiplexing operation may include a component copying operation. The target multiplexing position may be understood as a position where an effect processing component need to be multiplexed. In the embodiment of the present disclosure, performing the component multiplexing operation for the effect processing component in the target effect file, can be implemented by renting the effect processing component to obtain a new effect file, making the production of the effect file simple and convenient.

S120: processing the effect input information by the component scheduling file and the effect processing component, to obtain target effect information corresponding to the effect input information, and displaying the target effect information on the client.

The target effect information can be understood as effect information that needs to be displayed on the client obtained after performing the effect processing on effect input information.

Specifically, by executing the component scheduling file, the effect processing component may be first loaded, and then the loaded effect processing component may be called to process the effect input information. Then, the processing result of the effect processing component can be obtained, that is, the target effect information corresponding to the effect input information. After the target effect information is obtained, the target effect information may be displayed on the client.

On the basis of the above embodiments, in an embodiment of the present disclosure, after the effect processing component being loaded using the component scheduling file and after the processing result of a single effect processing component being obtained, the effect processing component may be unloaded using the component scheduling file to reduce memory consumption and improve effect processing efficiency.

According to the technical solution of the embodiment of the present disclosure, obtaining effect input information and a target effect file in response to an effect processing request entered on a client, wherein the target effect file includes at least one effect processing component and a component scheduling file, the component scheduling file includes a component scheduling logic for scheduling the effect processing component; and processing the effect input information by the component scheduling file and the effect processing component, to obtain target effect information corresponding to the effect input information, and displaying the target effect information on the client. In the technical scheme, the target effect file is componentized to the effect processing component, and component division with high cohesion and low coupling for the target effect file is realized, thereby improving the reusability and portability of the effect component code. Processing the effect input information with the component scheduling file and the effect processing component to obtain the target effect information corresponding to the effect input information and displaying the target effect information on the client. The technical solution of the embodiment of the present disclosure solves the problem that in the related art, which is the code in the effect file has poor readability and is inconvenient for subsequent maintenance of the effect file, realizes the componentization of the effect file in the effect processing, and can improve the readability and maintainability of the code in the effect file.

FIG. 2 is a schematic flow diagram of another effect processing method provided by an embodiment of the present disclosure. In the technical solution of the present embodiment is based on the above embodiment. Optionally, the component scheduling logic includes component input information and a component output effect of the effect processing component; and processing the effect input information by the component scheduling file and the effect processing component to obtain the target effect information corresponding to the effect input information, includes scheduling the effect input information, the effect processing component, and the component input information and the component output effect of the effect processing component, according to the component scheduling logic by the component scheduling file, to obtain the target effect information corresponding to the effect input information. For detailed embodiments, see the description of this embodiment. Technical features that are the same or similar to those of the foregoing embodiments will not be described herein. As shown in FIG. 2, the method of the present embodiment may specifically include:

S210, obtaining effect input information and a target effect file in response to an effect processing request entered on a client, wherein the target effect file includes at least one effect processing component and a component scheduling file, the component scheduling file includes a component scheduling logic for scheduling the effect processing component, and the component scheduling logic includes component input information and a component output effect of the effect processing component.

The component input information can be understood as information that the effect processing component can process. The component output effect can be understood as an effect obtained by processing component input information with the effect processing component. A number of component input information in the effect processing component may be one, two, or more. When the effect processing component includes a plurality pieces of component input information, the information types of the plurality pieces of the component input information may be the same or different. Similarly, a number of component output effect in the effect processing component can be one, two or more.

S220: scheduling the effect input information, the effect processing component, and the component input information and the component output effect of the effect processing component, according to the component scheduling logic by the component scheduling file, to obtain the target effect information corresponding to the effect input information and displaying the target effect information on the client.

As another alternative to the embodiment of the present disclosure, when the number of effect processing components is one, the effect input information can be first transferred to the component input information of the effect processing component with the component scheduling file according to the component scheduling logic, and the component output effect of the effect processing component can be obtained by processing the component input information by the first one effect processing component. After obtaining the component output effect of the effect processing component, the component output effect of the effect processing component can be used as target effect information corresponding to the effect input information and displayed on the client.

As an optional implementation of the embodiment of the present disclosure, when the number of effect processing components is multiple, the component execution logic of each effect processing component can be determined based on the component scheduling logic in the component scheduling file, wherein the component execution logic includes a serial execution logic and a parallel execution logic. When the component execution logic of each effect processing component is the parallel execution logic, the execution body (e.g., client or cloud) of each effect processing component can be determined. Further, each effect processing component can be loaded to the corresponding execution body. For each effect processing component, when the executing body of the effect processing component obtains the component input information corresponding to the effect processing component, the effect processing component can be executed.

When the component execution logic of each effect processing component is the serial execution logic, each effect processing component can be scheduled in turn according to the serial execution logic. Specifically, according to the component scheduling logic, the component scheduling file first transfers the effect input information to the component input information of the first one effect processing component, and then processes the component input information with the first one effect processing component to obtain the component output effect of the first one effect processing component. Then, the component output effect of the first one effect processing component are transferred to the component input information of the second one effect processing component. Further, the component output effect of the first effect processing component can be processed by the second one effect processing component. By analogy, the component input information of the current effect processing component can be used as the component output effect of the previous effect processing component, and the component output effect of the current effect processing component can be used as the component input information of the next effect processing component. When the component output effect of the last effect processing component is obtained, it can be determined that the component output effect of the last effect processing component is the target effect information corresponding to the effect input information and displayed on the client.

Illustratively, the effect processing component may include a first processing component, a second processing component and a third processing component. The component scheduling logic in the component scheduling file is to first schedule the first processing component to process the effect input information, then schedule the second processing component to process the effect output by the first processing component, and then schedule the third processing component to process the effect output by the second processing component.

Based on this, the component scheduling file schedules the effect input information, the effect processing component, the component input information of the effect processing component and the component output effect according to the component scheduling logic, to obtain the target effect information corresponding to the effect input information. Specifically, the effect input information can be obtained with the component scheduling file, transmitted to the component input information of the first processing component, and processed by executing the first processing component. Then, the component output effect of the first processing component is transmitted to the component input information of the second processing component, and the component output effect of the first processing component is processed by executing the second processing component to obtain the component output effect of the second processing component. Then, the component output effect of the second processing component is transmitted to the component input information of the third processing component, and the component output effect of the second processing component is processed by executing the third processing component to obtain the component output effect of the third processing component, that is, the target effect information corresponding to the effect input information is obtained.

In the technical scheme of the embodiment of the disclosure, the component scheduling logic includes the component input information and the component output effect of the effect processing component. According to the component scheduling logic, the component scheduling file schedules the effect input information, the effect processing component, the component input information and the component output effect of the effect processing component to obtain the target effect information corresponding to the effect input information, and further optimizes the function of scheduling the component input information and the component output effect of the effect processing component in the component scheduling logic.

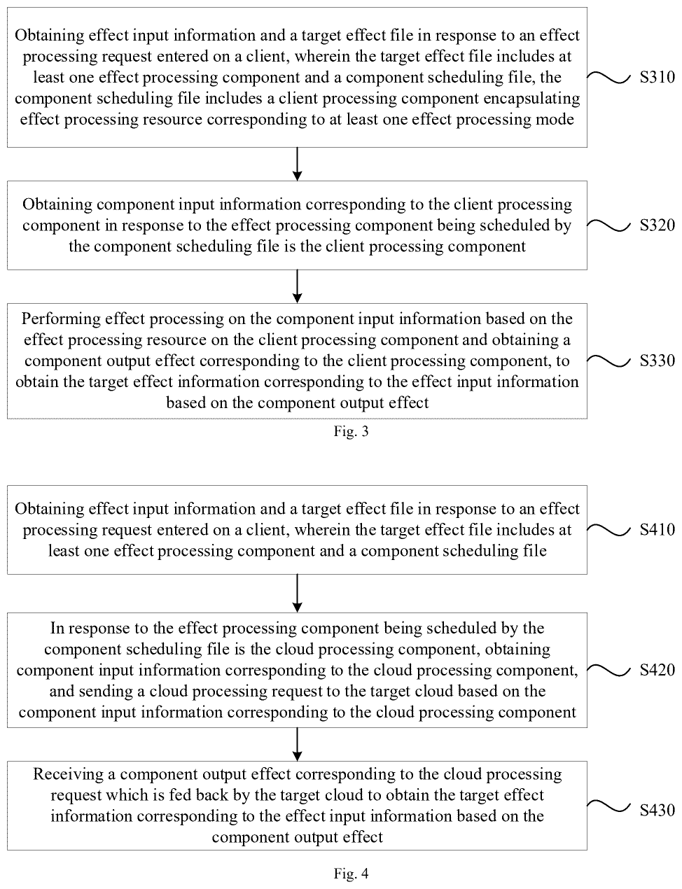

FIG. 3 is a schematic flow diagram of another effect processing method provided by an embodiment of the present disclosure. According to the technical solution of the present embodiment, on the basis of the above embodiment, optionally, the effect processing component includes a client processing component encapsulating effect processing resource corresponding to at least one effect processing mode; and processing the effect input information by the component scheduling file and the effect processing component to obtain the target effect information corresponding to the effect input information includes: obtaining component input information corresponding to the client processing component in response to the effect processing component being scheduled by the component scheduling file is the client processing component; and performing effect processing on the component input information based on the effect processing resource on the client processing component and obtaining a component output effect corresponding to the client processing component, to obtain the target effect information corresponding to the effect input information based on the component output effect. For detailed embodiments, see the description of this embodiment. Technical features that are the same or similar to those of the foregoing embodiments will not be described herein. As shown in FIG. 3, the method of the present embodiment may specifically include:

S310, obtaining effect input information and a target effect file in response to an effect processing request entered on a client, wherein the target effect file includes at least one effect processing component and a component scheduling file, the component scheduling file includes a client processing component encapsulating effect processing resource corresponding to at least one effect processing mode.

The effect processing resource can be understood as a resource which is needed for effect processing according to effect processing mode. The effect processing resource may include at least one of pictures, models, shaders and code (algorithm) files including the effect processing logic. The code file including effect processing logic may include calling at least one selected from a group consisting of an effect processing algorithm and an interactive operation detection logic.

S320, obtaining component input information corresponding to the client processing component in response to the effect processing component being scheduled by the component scheduling file is the client processing component.

Specifically, in response to the effect processing component scheduled by the component scheduling file is the client processing component, the component input information corresponding to the client processing component can be obtained. In the embodiment of the present disclosure, the component input information corresponding to the client processing component can be the effect input information, or the component output effect which is fed back by the cloud processing component.

S330, performing effect processing on the component input information based on the effect processing resource on the client processing component and obtaining a component output effect corresponding to the client processing component, to obtain the target effect information corresponding to the effect input information based on the component output effect.

In the embodiment of the present disclosure, the effect processing resource(s) for processing the component input information can be the effect processing resource(s) corresponding to one effect processing mode or the effect processing resource(s) corresponding to multiple effect processing modes.

As an optional implementation in the embodiment of the present disclosure, when the client processing component is encapsulated with an effect processing resource corresponding to an effect processing mode, the component input information can be processed with the effect processing resource corresponding to the effect processing mode, to obtain an effect processing result of the effect processing mode. Further, the effect processing result can be used as the component output effect corresponding to the client processing component. So that the target effect information corresponding to the effect input information can be obtained based on the component output effect corresponding to the client processing component.

As another optional embodiment in the embodiment of the present disclosure, in response to that the client processing component is encapsulated with an effect processing resource(s) corresponding to various effect processing modes, the component input information can be processed with the effect processing resource(s) corresponding to each effect processing mode, so that the effect processing result corresponding to each effect processing mode can be obtained. After each effect processing result is obtained, the set of each effect processing result can be used as the component output effect corresponding to the client processing component. So that the target effect information corresponding to the effect input information can be obtained based on the effect output result.

In the technical scheme of the embodiment of the present disclosure, in response to that that the effect processing component of the component scheduling file scheduling is the client processing component, the component input information corresponding to the client processing component is obtained; performing effect processing on the component input information based on effect processing resource(s) in the client processing component to obtain component output effect corresponding to the client processing component, to obtain target effect information corresponding to the effect input information based on the component output effect, and realizing the function of effect processing by the client component.

FIG. 4 is a schematic flow diagram of another effect processing method provided by an embodiment of the present disclosure. In the technical solution of the present embodiment, on the basis of the above embodiment, optionally, processing the effect input information by the component scheduling file and the effect processing component to obtain the target effect information corresponding to the effect input information includes: in response to the effect processing component being scheduled by the component scheduling file is the cloud processing component, obtaining component input information corresponding to the cloud processing component, and sending a cloud processing request to the target cloud based on the component input information corresponding to the cloud processing component; and receiving a component output effect corresponding to the cloud processing request which is fed back by the target cloud to obtain the target effect information corresponding to the effect input information based on the component output effect. For detailed embodiments, see the description of this embodiment. Technical features that are the same or similar to those of the foregoing embodiments will not be described herein. As shown in FIG. 4, the method of the present embodiment may specifically include:

S410, obtaining effect input information and a target effect file in response to an effect processing request entered on a client, wherein the target effect file includes at least one effect processing component and a component scheduling file.

S420: in response to the effect processing component being scheduled by the component scheduling file is the cloud processing component, obtaining component input information corresponding to the cloud processing component, and sending a cloud processing request to the target cloud based on the component input information corresponding to the cloud processing component.

The cloud processing request can be a request to be sent to the target cloud for processing the component input information corresponding to the cloud processing component. The cloud processing request may carry component input information corresponding to the client processing component. The number of component input information in the cloud processing request may be one, two or more. When the number of component input information in the cloud processing request is multiple, the information types of each component input information may be the same or different.

Specifically, when the special effects processing component scheduled by the component scheduling file is a cloud processing component, the component input information corresponding to the cloud processing component can be obtained. After obtaining the component input information corresponding to the cloud processing component, a cloud processing request can be generated based on the component input information corresponding to the cloud processing component. After the cloud processing request is generated, the cloud processing request can be sent to the target cloud. In the embodiment of the present disclosure, the component input information corresponding to the cloud processing component may be the component output effect of the client processing component, or may be the effect input information.

S430: receiving a component output effect corresponding to the cloud processing request which is fed back by the target cloud to obtain the target effect information corresponding to the effect input information based on the component output effect.

Specifically, the component output effect corresponding to the cloud processing request which is fed back by the target cloud is received. The target effect information corresponding to the effect input information can be obtained based on the component output effect. After obtaining the target effect information, the target effect information can be displayed on the client.

In the technical scheme of the embodiment of the present disclosure, in response to that the effect processing component scheduled by the component scheduling file is the cloud processing component, the component input information corresponding to the cloud processing component is obtained, and the cloud processing request is sent to the target cloud based on the component input information corresponding to the cloud processing component; receiving the component output effect corresponding to the cloud processing request which is fed back by the target cloud, to obtain the target effect information corresponding to the effect input information based on the component output effect, and realizing the function of effect processing with the cloud processing component.

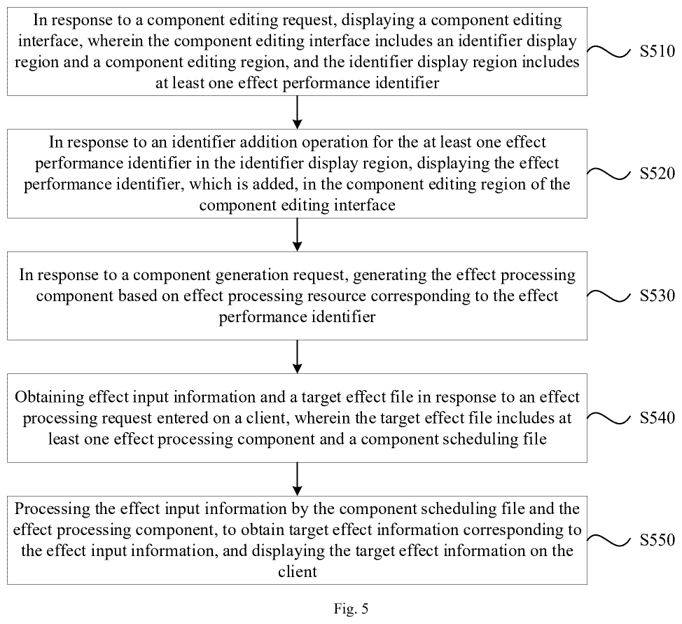

FIG. 5 is a schematic flow diagram of another effect processing method provided by an embodiment of the present disclosure. On the basis of the above embodiments, before obtaining the target effect file, the technical solution of the present embodiment optionally further includes: in response to a component editing request, displaying a component editing interface, wherein the component editing interface includes an identifier display region and a component editing region, and the identifier display region includes at least one effect performance identifier; in response to an identifier addition operation for the at least one effect performance identifier in the identifier display region, displaying the effect performance identifier, which is added, in the component editing region of the component editing interface; and in response to a component generation request, generating the effect processing component based on effect processing resource corresponding to the effect performance identifier. For detailed embodiments, see the description of this embodiment. Technical features that are the same or similar to those of the foregoing embodiments will not be described herein. As shown in FIG. 5, the method of the present embodiment may specifically include:

S510, in response to a component editing request, displaying a component editing interface, wherein the component editing interface includes an identifier display region and a component editing region, and the identifier display region includes at least one effect performance identifier.

In an embodiment of the present disclosure, the component editing request may be understood as a request for displaying a component editing interface. Optionally, the component editing request may be a piece of code instruction, or may be an identifier trigger operation acting on an application identifier corresponding to a component editing application; alternatively, it may be a control trigger operation acting on component edit control. The component editing interface may include an identifier display region and a component editing region. In the embodiment of the present disclosure, the identifier display region and the component editing region in the component editing interface may adopt an upper and lower structure layout or a left and right structure layout, which is not specifically limited here, and the layout structures of the identifier display region and the component editing region in the component editing interface may be set according to actual needs.

The identifier display region can be understood as an region used for displaying an effect performance identifier. The number of the effect performance identifier displayed in the identifier display region may be one, two or more. The effect performance identifier displayed in the identifier display region may be a default effect performance identifier which is preset, or may be automatically updated according to the change of the effect processing mode. For example, when a new effect processing mode is added, an effect performance identifier corresponding to the new effect processing mode may be obtained based on the effect processing resource corresponding to the new effect processing mode, so that the effect performance identifier may be added to the identifier display region. Alternatively, when an effect processing mode is deleted, the identifier corresponding to the effect processing mode may be determined, and the effect performance identifier corresponding to the effect processing mode may be deleted from the identifier display region. Alternatively, when the effect processing mode is modified, the modified effect processing mode can be obtained, so that an effect performance identifier corresponding to the effect processing resource of the modified effect processing mode can be generated. Furthermore, the effect performance identifier in the identifier display region can be updated.

The component editing region can be understood as an region for adding an effect performance identifier in the identifier display region. The region size of the component editing region may be a fixed size, or a size obtained by dynamically adjusting the region size of a region occupied by the added effect performance identifier and a preset size interval. Specifically, when the region size is smaller than the minimum size of the preset size interval, the region size of the component editing region may be the minimum size of the preset size interval. Alternatively, when the region size is between a minimum size and a maximum size of a preset size interval, the region size of the component editing region may be the region size; alternatively, when the regional size exceeds the maximum size of the preset size interval, the region size of the component editing region may be the maximum size of the preset size interval.

The effect performance identifier can be used to distinguish different effect processing modes. There are many ways to obtain the effect performance identifier, for example, the effect performance identifier corresponding to the effect processing mode can be generated according to the effect processing resource of the effect processing mode; alternatively, the effect performance identifier being input for the effect processing mode may be received. Optionally, the effect performance identifier may be at least one selected from a group consisting of a graphical identifier and a text-type identifier.

S520, in response to an identifier addition operation for the at least one effect performance identifier in the identifier display region, displaying the effect performance identifier, which is added, in the component editing region of the component editing interface.

The identifier adding operation can be used to add the effect performance identifier, which is in the identifier display region, to the component editing interface. It should be noted that the effect performance identifier added to the component editing region may be one or more. When a plurality of effect performance identifiers are added to the component editing region, the effect performance identifiers being added to the component editing region may be the same or different.

As an optional embodiment of the embodiment of the present disclosure, in the embodiment of the present disclosure, a number of effect performance identifier selected by an identifier selection operation may be one or more in response to the identifier selection operation for the effect performance identifier in the identifier display region. In one embodiment, when the number of selected effect performance identifier is one, the selected effect performance identifier may be displayed in the component editing interface. In another embodiment, when the number of selected effect performance identifier is a plurality of effect performance identifiers, each of the effect performance identifiers may be arranged in a time sequence in which each of the effect performance identifiers being selected. Alternatively, each of the effect performance identifiers may be randomly arranged; then displayed in the component editing interface.

As another optional embodiment of the embodiment of the present disclosure, in response to performing an identifier drag-and-drop operation for the effect performance identifier in the identifier display region to the component editing region, the dragged effect performance identifier is displayed in the component editing region. In the embodiment of the present disclosure, when the number of effect performance identifiers to be displayed in the component editing region is multiple, a plurality of effect performance identifiers to be dragged may be selected in the identifier display region first; then, in response to receiving the first drag-and-drop operation for all selected effect performance identifiers to be dragged, all the selected effect performance identifiers to be dragged may be uniformly dragged to the component editing region. Alternatively, a separate second identifier drag-and-drop operation may be performed for each effect performance identifier, so that the dragged effect performance identifiers may be dragged one by one to the component editing region.

On the basis of the above embodiment, in order to facilitate a cancellation of the display of the effect performance identifier in the component editing interface, further include: deleting the selected effect performance identifier or the dragged effect performance identifier in the component editing interface in response to an identifier selection operation for the effect performance identifier in the component editing interface, or in response to an identifier drag-and-drop operation for dragging the effect performance identifier in the component editing interface to the identifier display interface.

It can be understood that after the addition of each of the effect performance identifiers in the component editing region is completed, the connection relationship between the effect performance identifiers may be automatically established, for example, the connection relationship of the effect performance identifiers may be established based on position information of each effect performance identifier; alternatively, the connection relationship between the effect performance identifiers may be established according to the time in which each effect performance identifier being selected. Alternatively, the effect performance identifier selected in the identifier display region may be dragged and dropped to a relationship establishment sub-region corresponding to the target effect performance identifier in the component editing region, to automatically establish relationship between the selected effect performance identifier and the target effect performance identifier. Furthermore, a connection relationship between the effect performance identifiers may be established by a connection operation for every two of the effect performance identifiers. For example, in response to identifier selection operation for the first effect identifier and the second effect identifier in the component editing region, a connection of the first effect identifier and the second effect identifier is established.

S530, in response to a component generation request, generating the effect processing component based on effect processing resource corresponding to the effect performance identifier.

The component generation request may be understood as a request for generating an effect processing component based on the corresponding effect processing resource of the effect performance identifier. The component generation request may be a trigger operation, control, acting on the preset component generation control, wherein the preset component generation control may be located in the component editing region or in the identifier display region; alternatively, it may be a piece of code instruction for component generation. The component generation request may carry at least one effect performance identifier.

Specifically, after receiving the component generation request, the effect performance identifier in the component generation request may be determined. When the number of effect performance identifier is one, the effect processing mode corresponding to the effect performance identifier may be determined, and the effect processing resource of the effect processing mode may be determined. Then, the effect processing component may be generated based on the effect processing resource(s). When the number of the effect performance identifiers is multiple, a connection relationship of each of the effect performance identifiers may be determined; accordingly, the effect processing component can be generated based on the connection relationship and the effect processing resource corresponding to each of the effect performance identifiers.

S540, obtaining effect input information and a target effect file in response to an effect processing request entered on a client, wherein the target effect file includes at least one effect processing component and a component scheduling file.

S550: processing the effect input information by the component scheduling file and the effect processing component, to obtain target effect information corresponding to the effect input information, and displaying the target effect information on the client.

According to the technical solution of the embodiment of the present disclosure, a component editing interface is displayed in response to a component editing request, wherein the component editing interface includes an identifier display region and a component editing region; the identifier display region includes at least one effect performance identifier; in response to an identifier addition operation for the at least one effect identifier in the identifier display region, displaying the added effect identifier in the component editing region of the component editing interface; in response to the component generation request, an effect processing component is generated based on the corresponding effect processing resource of the effect performance identifier, and a visual editing function supporting the effect processing component is realized.

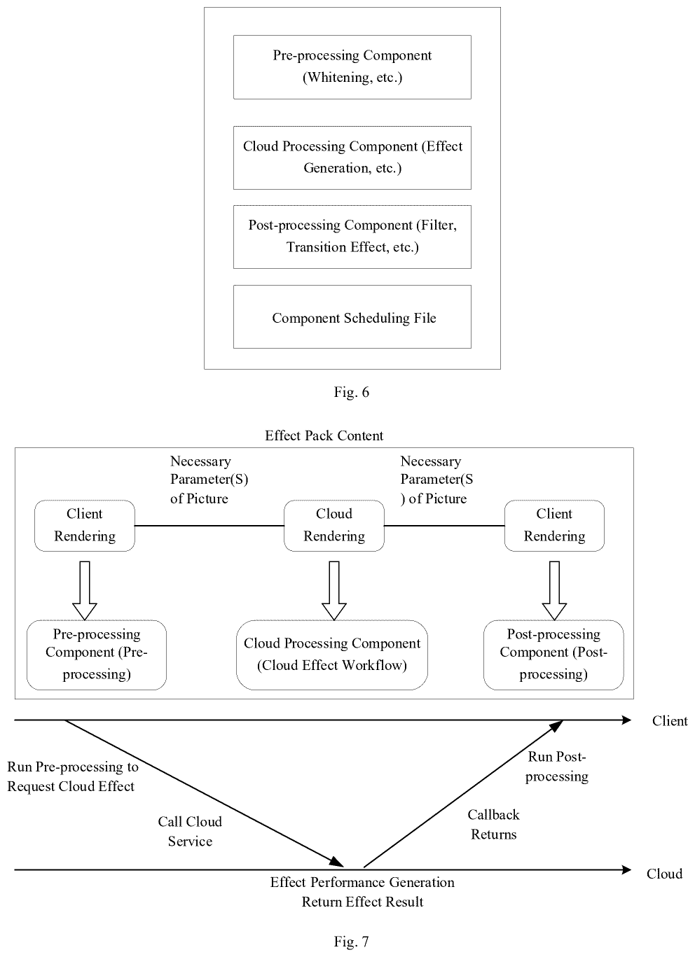

As an optional embodiment of the embodiment of the present disclosure, as shown in FIG. 6, the effect processing component in the target effect file may include a pre-processing component, a cloud processing component, a post-processing component, and a component scheduling file. The pre-processing component and the post-processing component may run in a client, that is, the pre-processing component and the post-processing component may be client processing components. Cloud processing components can run in the cloud. The component scheduling file is a component scheduling logic written for the pre-processing component, the cloud processing component, or the post-processing component. Referring to FIG. 7, the effect processing step based on the target effect file may include:
1. receiving the effect processing request by a client, to obtain the effect input information and determine the target effect file. Furthermore, the effect input information can be transferred to a component input parameter(s) of the pre-processing component in the target effect file with the component scheduling file in the target effect file, and the effect input information can be processed with the pre-processing component, that is, a pre-processing can be executed. Then, the first component output effect of the pre-processing component can be obtained and a cloud processing request can be generated. So that the first component output effect and the cloud processing request can be sent to a cloud (cloud end), that is, request for a cloud effect.
2. receiving, by the cloud, the cloud processing request and the first component output effect sent by the client. Based on the cloud processing request, the first component output effect can be transferred to the component input parameter of the cloud processing component in the target effect file with the component scheduling logic of the component scheduling file, and the first component output effect can be processed by the cloud processing component, to obtain the second component output effect of the cloud processing component. At this time, the effect performance is generated, to obtain the effect performance. Furthermore, the generated effect performance, that is, the effect output by the second component can be fed back to the client.

The cloud processing component is configured to describe a cloud processing flow to be executed in the target cloud. The cloud processing flow includes at least one cloud processing node. The cloud processing node may be obtained based on a cloud service abstraction. It should be noted that multiple cloud processing nodes can be executed in parallel or in series.

For example, as shown in FIG. 8, after the client renders a graphic, the client sends a rendering result to the cloud, and the cloud processes the rendering result with at least one cloud service to obtain an effect processing result, that is, the component output effect of the cloud processing component, and feeds it back to the client. After that, the client processes the effect processing result which is fed back from the cloud with the client processing component (algorithm), and renders a result processed by the algorithm, to obtain an effect generation map, that is, the target effect information, at the client.
3. The second component output effect is received from the cloud by the client, and the second component output effect can be transferred to the component input information of the post-processing component in the target effect file with the component scheduling file, and an effect processing can be performed on the second component output effect with the post-processing component. So that the component output effect of the post-processing component can be obtained, that is, target effect information corresponding to the effect input information can be obtained.

It should be noted that, in the embodiment of the present disclosure, the client does not need to perceive the effect processing process in the cloud. For the cloud, it is necessary to perceive the effect processing process of client. The collaboration between the client and the cloud can be configured through the component scheduling file in the target effect file, realizing the decoupling of the effect processing.

According to the technical solution of the embodiment of the present disclosure, after the component of the target effect file is componentized to the effect processing component running on the client and the cloud respectively, an effect can be processed in a collaborative manner between the client and the cloud, which can effectively improve the processing efficiency of effects, and can also provide a cloud effect processing service for different clients, so that different clients can get a same cloud processing component to output effect.

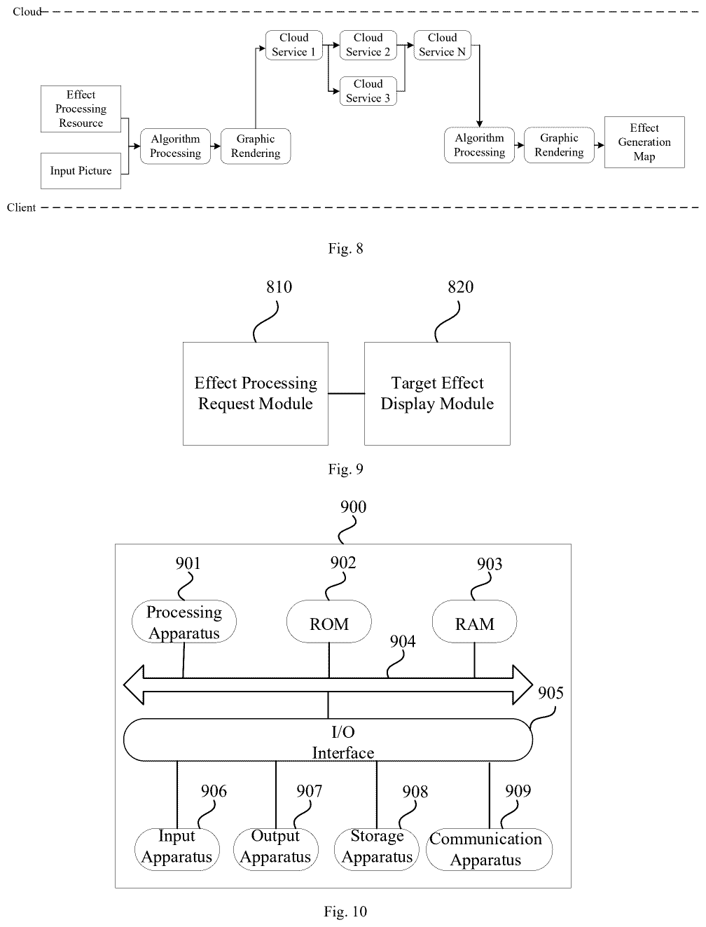

FIG. 9 is a schematic structural diagram of an effect processing device according to an embodiment of the present disclosure. As shown in FIG. 9, the device includes an effect processing request module 810 and a target effect display module 820.

The effect processing request module 810 is configured to obtain effect input information and a target effect file in response to an effect processing request entered on a client, wherein the target effect file includes at least one effect processing component and a component scheduling file, the component scheduling file includes a component scheduling logic for scheduling the effect processing component; the target effect display module 820 is configured to process the effect input information by the component scheduling file and the effect processing component, to obtain target effect information corresponding to the effect input information, and displaying the target effect information on the client.

According to the technical solution of the embodiment of the present disclosure, obtaining effect input information and a target effect file in response to an effect processing request entered on a client, wherein the target effect file includes at least one effect processing component and a component scheduling file, the component scheduling file includes a component scheduling logic for scheduling the effect processing component; and processing the effect input information by the component scheduling file and the effect processing component, to obtain target effect information corresponding to the effect input information, and displaying the target effect information on the client. In the technical scheme, the target effect file is componentized to the effect processing component, and component division with high cohesion and low coupling for the target effect file is realized, thereby improving the reusability and portability of the effect component code. Processing the effect input information with the component scheduling file and the effect processing component to obtain the target effect information corresponding to the effect input information and displaying the target effect information on the client. The technical solution of the embodiment of the present disclosure solves the problem that in the related art, which is the code in the effect file has poor readability and is inconvenient for subsequent maintenance of the effect file, realizes the componentization of the effect file in the effect processing, and can improve the readability and maintainability of the code in the effect file.

On the basis of each of the above optional technical solution, optionally, the component scheduling logic includes component input information and a component output effect of the effect processing component; the target effect display module 820 is specifically configured to schedule the effect input information, the effect processing component, and the component input information and the component output effect of the effect processing component, according to the component scheduling logic by the component scheduling file, to obtain the target effect information corresponding to the effect input information.

On the basis of each of the above optional technical solutions, optionally, the effect processing component includes a client processing component encapsulating effect processing resource corresponding to at least one effect processing mode; the target effect display module 820, is further configured to obtain component input information corresponding to the client processing component in response to the effect processing component being scheduled by the component scheduling file is the client processing component; and performing effect processing on the component input information based on the effect processing resource on the client processing component and obtaining a component output effect corresponding to the client processing component, to obtain the target effect information corresponding to the effect input information based on the component output effect.

On the basis of each of the above optional technical solutions, optionally, the effect processing component includes a cloud processing component, the cloud processing component is configured to describe a cloud processing flow to be executed in a target cloud, and the cloud processing flow includes at least one cloud processing node.

On the basis of each of the above optional technical solutions, optionally, the target effect display module 820 is configured to, in response to the effect processing component being scheduled by the component scheduling file is the cloud processing component, obtain component input information corresponding to the cloud processing component, and send a cloud processing request to the target cloud based on the component input information corresponding to the cloud processing component; and receive a component output effect corresponding to the cloud processing request which is fed back by the target cloud to obtain the target effect information corresponding to the effect input information based on the component output effect.

On the basis of each of the above optional technical solutions, optionally, further includes a target effect file modification module, configured to receive a field editing operation for a target field in a predefined field injection function, wherein the field injection function includes a node identifier corresponding to the cloud processing node; and inject the target field, which is edited, in the field injection function into a node code of the cloud processing node corresponding to the node identifier.

On the basis of each of the above optional technical solutions, optionally, an input parameter of an effect processing operation corresponding to the cloud processing node is configured with a placeholder.

On the basis of each of the above optional technical solutions, optionally, further includes an effect processing component multiplexing module, configured to determining, after the target effect file, a target multiplexing location for the effect processing component based on the component multiplexing operation, and adding the effect processing component to the target multiplexing location in response to a component multiplexing operation for the effect processing component in the target effect file.

On the basis of each of the above optional technical solutions, optionally, further includes an effect processing component generation module, configured to: in response to a component editing request, displaying a component editing interface, wherein the component editing interface includes an identifier display region and a component editing region, and the identifier display region includes at least one effect performance identifier; in response to an identifier addition operation for the at least one effect performance identifier in the identifier display region, displaying the effect performance identifier, which is added, in the component editing region of the component editing interface; and in response to a component generation request, generating the effect processing component based on effect processing resource corresponding to the effect performance identifier.

The effect processing apparatus according to the embodiments of the present disclosure can execute the effect processing method according to any embodiment of the present disclosure, and has functional modules for executing the method and corresponding beneficial effects.

It is worth noting that each unit and module included in the above apparatus is only divided according to functional logic, but it is not limited to the above division, as long as the corresponding functions can be realized. In addition, the specific names of each functional unit are only for the convenience of distinguishing each other, and are not used to limit the protection scope of the disclosed embodiment.

FIG. 10 is a schematic structural diagram of an electronic device according to an embodiment of the present disclosure.

Reference is made to FIG. 10 below, which illustrates a schematic structural diagram of an electronic device 900 (such as a terminal device or a server) suitable for implementing the embodiments of the present disclosure. The terminal device in the embodiments of the present disclosure may include, but is not limited to, mobile terminals such as a mobile phone, a laptop, a digital broadcast receiver, a personal digital assistant (PDA), a tablet computer, a portable multimedia player (PMP), a vehicle-mounted terminal (such as a vehicle-mounted navigation terminal), etc., and fixed terminals such as a digital TV, a desktop computer, etc. The electronic device shown in FIG. 10 is only an example, and should not impose any limitation to the function and usage scope of the embodiments of the present disclosure.

As shown in FIG. 10, the electronic device 900 may include a processing apparatus 901 (such as a central processing unit, a graphics processing unit, etc.), which may perform various appropriate actions and processing according to a program stored in a read-only memory (ROM) 902 or a program loaded from a storage apparatus 908 into a random access memory (RAM) 903. The RAM 903 also stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906, including, for example, a touchscreen, a touchpad, a keyboard, a mouse, a camera, a microphone, an accelerometer, a gyroscope, etc.; an output apparatus 907, including, for example, a liquid crystal display (LCD), a speaker, a vibrator, etc.; a storage apparatus 908, including, for example, a magnetic tape, a hard disk, etc.; and a communication apparatus 909. The communication apparatus 909 may allow the electronic device 900 to perform wireless or wired communication with other devices to exchange data. Although FIG. 10 shows the electronic device 900 having various apparatuses, it should be understood that not all of the illustrated apparatuses are required to be implemented or provided. Alternatively, more or fewer apparatuses may be implemented or provided.

Particularly, according to the embodiments of the present disclosure, the processes described above with reference to the flowcharts may be implemented as a computer software program. For example, an embodiment of the present disclosure includes a computer program product, which includes a computer program carried on a non-transitory computer-readable medium. The computer program includes program codes for executing the method shown in the flowchart. In such an embodiment, the computer program may be downloaded and installed from a network through the communication apparatus 609, or may be installed from the storage apparatus 608, or may be installed from the ROM 602. When the computer program is executed by the processing apparatus 601, the above functions defined in the method of the embodiments of the present disclosure are executed.

Names of messages or information exchanged among multiple apparatuses in the embodiment of the present disclosure are only used for illustrative purposes, and but not limit the scope of these messages or information.

The electronic device provided by the embodiments of the present disclosure belongs to a same inventive concept as the effect processing method provided by the above embodiments, and the technical details which not described in detail in this embodiment can be found in the above embodiment, and this embodiment has the same beneficial effects as the above embodiments.

An embodiment of the present disclosure provides a computer storage medium on which a computer program is stored, which, when executed by a processor, realizes the special effect processing method provided in the above embodiment.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that may be used by or in combination with an instruction execution system, apparatus, or device. In the present disclosure, the computer-readable signal medium may include a data signal propagated in a baseband or as a part of a carrier wave, and computer-readable program codes are carried in the data signal. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes included on the computer-readable medium may be transmitted by any suitable medium, including but not limited to a wire, an optical cable, a radio frequency (RF), etc., or any suitable combination thereof.

In some implementations, the client and the server may communicate using any currently known or future developed network protocol such as a hypertext transfer protocol (HTTP), and may be interconnected with any form or medium of digital data communication (for example, a communication network). Examples of the communication network include a local area network (“LAN”), a wide area network (“WAN”), an internetwork (for example, the Internet), a peer-to-peer network (for example, an ad hoc network), and any currently known or future developed network.

The above computer-readable medium may be included in the above electronic device; or may exist alone without being assembled into the electronic device.

The above computer-readable medium carries one or more programs, and when the above one or more programs are executed by the electronic device, the electronic device is caused to: obtaining effect input information and a target effect file in response to an effect processing request entered on a client, wherein the target effect file includes at least one effect processing component and a component scheduling file, the component scheduling file includes a component scheduling logic for scheduling the effect processing component; and processing the effect input information by the component scheduling file and the effect processing component, to obtain target effect information corresponding to the effect input information, and displaying the target effect information on the client.

The computer program codes for executing the operations of the present disclosure may be written in one or more programming languages or a combination thereof, where the above programming languages include object-oriented programming languages such as Java, Smalltalk, C++, and also include conventional procedural programming languages such as the “C” programming language or similar programming languages. The program codes may be executed entirely on a user computer, partly on a user computer, as a stand-alone software package, partly on a user computer and partly on a remote computer, or entirely on a remote computer or a server. In the case of involving the remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that, in some alternative implementations, the functions noted in the blocks may also occur in an order different from that noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. The name of a module does not constitute a limitation on the module itself under certain circumstances, for example, the first display module may also be described as “a module for displaying the target delivery content when receiving, during a display process of a text, the image generation instruction associated with the delivery content”.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides an effect processing method, including: obtaining effect input information and a target effect file in response to an effect processing request entered on a client, wherein the target effect file includes at least one effect processing component and a component scheduling file, the component scheduling file includes a component scheduling logic for scheduling the effect processing component; and processing the effect input information by the component scheduling file and the effect processing component, to obtain target effect information corresponding to the effect input information, and displaying the target effect information on the client.

According to one or more embodiments of the present disclosure, Example 2 provides the method of Example 1, further including: optionally, the component scheduling logic includes component input information and a component output effect of the effect processing component; and processing the effect input information by the component scheduling file and the effect processing component to obtain the target effect information corresponding to the effect input information includes: scheduling the effect input information, the effect processing component, and the component input information and the component output effect of the effect processing component, according to the component scheduling logic by the component scheduling file, to obtain the target effect information corresponding to the effect input information.

According to one or more embodiments of the present disclosure, Example 3 provides the method of Example 1, further including: optionally, the effect processing component includes a client processing component encapsulating effect processing resource corresponding to at least one effect processing mode; and processing the effect input information by the component scheduling file and the effect processing component to obtain the target effect information corresponding to the effect input information includes: obtaining component input information corresponding to the client processing component in response to the effect processing component being scheduled by the component scheduling file is the client processing component; and performing effect processing on the component input information based on the effect processing resource on the client processing component and obtaining a component output effect corresponding to the client processing component, to obtain the target effect information corresponding to the effect input information based on the component output effect.

According to one or more embodiments of the present disclosure, Example 4 provides the method of Example 1, further including: optionally, the effect processing component includes a cloud processing component, the cloud processing component is configured to describe a cloud processing flow to be executed in a target cloud, and the cloud processing flow includes at least one cloud processing node.

According to one or more embodiments of the present disclosure, Example 5 provides the method of Example 1, further including: optionally, processing the effect input information by the component scheduling file and the effect processing component to obtain the target effect information corresponding to the effect input information includes: in response to the effect processing component being scheduled by the component scheduling file is the cloud processing component, obtaining component input information corresponding to the cloud processing component, and sending a cloud processing request to the target cloud based on the component input information corresponding to the cloud processing component; and receiving a component output effect corresponding to the cloud processing request which is fed back by the target cloud to obtain the target effect information corresponding to the effect input information based on the component output effect.

According to one or more embodiments of the present disclosure, Example 6 provides the method of Example 1, further including: optionally, after obtaining the target effect file, the method further includes: receiving a field editing operation for a target field in a predefined field injection function, wherein the field injection function includes a node identifier corresponding to the cloud processing node; and injecting the target field, which is edited, in the field injection function into a node code of the cloud processing node corresponding to the node identifier.

According to one or more embodiments of the present disclosure, Example 7 provides the method of Example 1, further including: optionally, an input parameter of an effect processing operation corresponding to the cloud processing node is configured with a placeholder.

According to one or more embodiments of the present disclosure, Example 8 provides the method of Example 1, further including, optionally, after obtaining the target effect file, the method further includes: in response to a component multiplexing operation for the effect processing component in the target effect file, determining a target multiplexing location for the effect processing component based on the component multiplexing operation, and adding the effect processing component to the target multiplexing location.

According to one or more embodiments of the present disclosure, Example 9 provides the method of Example 1, further including: optionally, before obtaining the target effect file, the method further includes: in response to a component editing request, displaying a component editing interface, wherein the component editing interface includes an identifier display region and a component editing region, and the identifier display region includes at least one effect performance identifier; in response to an identifier addition operation for the at least one effect performance identifier in the identifier display region, displaying the effect performance identifier, which is added, in the component editing region of the component editing interface; and in response to a component generation request, generating the effect processing component based on effect processing resource corresponding to the effect performance identifier.

According to one or more embodiments of the present disclosure, Example 10 provides an effect processing apparatus, including: an effect processing request module, configured to obtain effect input information and a target effect file in response to an effect processing request entered on a client, wherein the target effect file includes at least one effect processing component and a component scheduling file, the component scheduling file includes a component scheduling logic for scheduling the effect processing component; and a target effect display module, configured to process the effect input information by the component scheduling file and the effect processing component, to obtain target effect information corresponding to the effect input information, and displaying the target effect information on the client.

The above description is only preferred embodiments of the present disclosure and an illustration of the applied technical principles. Those skilled in the art should understand that the scope of disclosure involved in the present disclosure is not limited to the technical solution formed by a specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are only example forms of implementing the claims. Regarding the apparatus in the above embodiments, the specific manner in which each module performs operations has been described in detail in the embodiments related to the method, and will not be described in detail here.

1. An effect processing method, comprising:
obtaining effect input information and a target effect file in response to an effect processing request entered on a client, wherein the target effect file comprises at least one effect processing component and a component scheduling file, the component scheduling file comprises a component scheduling logic for scheduling the effect processing component; and
processing the effect input information by the component scheduling file and the effect processing component, to obtain target effect information corresponding to the effect input information, and displaying the target effect information on the client.

2. The effect processing method according to claim 1, wherein the component scheduling logic comprises component input information and a component output effect of the effect processing component; and processing the effect input information by the component scheduling file and the effect processing component to obtain the target effect information corresponding to the effect input information comprises:
scheduling the effect input information, the effect processing component, and the component input information and the component output effect of the effect processing component, according to the component scheduling logic by the component scheduling file, to obtain the target effect information corresponding to the effect input information.

3. The effect processing method according to claim 1, wherein the effect processing component comprises a client processing component encapsulating effect processing resource corresponding to at least one effect processing mode; and processing the effect input information by the component scheduling file and the effect processing component to obtain the target effect information corresponding to the effect input information comprises:
obtaining component input information corresponding to the client processing component in response to the effect processing component being scheduled by the component scheduling file is the client processing component; and
performing effect processing on the component input information based on the effect processing resource on the client processing component and obtaining a component output effect corresponding to the client processing component, to obtain the target effect information corresponding to the effect input information based on the component output effect.

4. The effect processing method according to claim 1, wherein the effect processing component comprises a cloud processing component, the cloud processing component is configured to describe a cloud processing flow to be executed in a target cloud, and the cloud processing flow comprises at least one cloud processing node.

5. The effect processing method according to claim 4, wherein processing the effect input information by the component scheduling file and the effect processing component to obtain the target effect information corresponding to the effect input information comprises:
in response to the effect processing component being scheduled by the component scheduling file is the cloud processing component, obtaining component input information corresponding to the cloud processing component, and sending a cloud processing request to the target cloud based on the component input information corresponding to the cloud processing component; and
receiving a component output effect corresponding to the cloud processing request which is fed back by the target cloud to obtain the target effect information corresponding to the effect input information based on the component output effect.

6. The effect processing method according to claim 4, wherein after obtaining the target effect file, the method further comprises:
receiving a field editing operation for a target field in a predefined field injection function, wherein the field injection function comprises a node identifier corresponding to the cloud processing node; and
injecting the target field, which is edited, in the field injection function into a node code of the cloud processing node corresponding to the node identifier.

7. The effect processing method according to claim 4, wherein an input parameter of an effect processing operation corresponding to the cloud processing node is configured with a placeholder.

8. The effect processing method according to claim 1, wherein after obtaining the target effect file, the method further comprises:
in response to a component multiplexing operation for the effect processing component in the target effect file, determining a target multiplexing location for the effect processing component based on the component multiplexing operation, and adding the effect processing component to the target multiplexing location.

9. The effect processing method according to claim 1, wherein before obtaining the target effect file, the method further comprises:
in response to a component editing request, displaying a component editing interface, wherein the component editing interface comprises an identifier display region and a component editing region, and the identifier display region comprises at least one effect performance identifier;
in response to an identifier addition operation for the at least one effect performance identifier in the identifier display region, displaying the effect performance identifier, which is added, in the component editing region of the component editing interface; and
in response to a component generation request, generating the effect processing component based on effect processing resource corresponding to the effect performance identifier.

10. A electronic device, comprising:
at least a processor, and
a non-transitory memory with instructions thereon,
wherein the instructions upon execution by the processor, cause the processor to:
obtain effect input information and a target effect file in response to an effect processing request entered on a client, wherein the target effect file comprises at least one effect processing component and a component scheduling file, the component scheduling file comprises a component scheduling logic for scheduling the effect processing component; and
process the effect input information by the component scheduling file and the effect processing component, to obtain target effect information corresponding to the effect input information, and display the target effect information on the client.

11. The electronic device according to claim 10, wherein the component scheduling logic comprises component input information and a component output effect of the effect processing component; and when processing the effect input information by the component scheduling file and the effect processing component to obtain the target effect information corresponding to the effect input information, the processor is caused to:
schedule the effect input information, the effect processing component, and the component input information and the component output effect of the effect processing component, according to the component scheduling logic by the component scheduling file, to obtain the target effect information corresponding to the effect input information.

12. The electronic device according to claim 10, wherein the effect processing component comprises a client processing component encapsulating effect processing resource corresponding to at least one effect processing mode; and processing the effect input information by the component scheduling file and the effect processing component to obtain the target effect information corresponding to the effect input information, the processor is caused to:
obtain component input information corresponding to the client processing component in response to the effect processing component being scheduled by the component scheduling file is the client processing component; and
perform effect processing on the component input information based on the effect processing resource on the client processing component and obtaining a component output effect corresponding to the client processing component, to obtain the target effect information corresponding to the effect input information based on the component output effect.

13. The electronic device according to claim 10, wherein the effect processing component comprises a cloud processing component, the cloud processing component is configured to describe a cloud processing flow to be executed in a target cloud, and the cloud processing flow comprises at least one cloud processing node.

14. The electronic device according to claim 13, wherein processing the effect input information by the component scheduling file and the effect processing component to obtain the target effect information corresponding to the effect input information, the processor is caused to:
in response to the effect processing component being scheduled by the component scheduling file is the cloud processing component, obtain component input information corresponding to the cloud processing component, and sending a cloud processing request to the target cloud based on the component input information corresponding to the cloud processing component; and
receive a component output effect corresponding to the cloud processing request which is fed back by the target cloud to obtain the target effect information corresponding to the effect input information based on the component output effect.

15. The electronic device according to claim 13, wherein after obtaining the target effect file, the processor is further caused to:
receive a field editing operation for a target field in a predefined field injection function, wherein the field injection function comprises a node identifier corresponding to the cloud processing node; and
inject the target field, which is edited, in the field injection function into a node code of the cloud processing node corresponding to the node identifier.

16. The electronic device according to claim 13, wherein an input parameter of an effect processing operation corresponding to the cloud processing node is configured with a placeholder.

17. The electronic device according to claim 10, wherein after obtaining the target effect file, the processor is further caused to:
in response to a component multiplexing operation for the effect processing component in the target effect file, determine a target multiplexing location for the effect processing component based on the component multiplexing operation, and add the effect processing component to the target multiplexing location.

18. The electronic device according to claim 10, wherein before obtaining the target effect file the processor is further caused to:
in response to a component editing request, display a component editing interface, wherein the component editing interface comprises an identifier display region and a component editing region, and the identifier display region comprises at least one effect performance identifier;
in response to an identifier addition operation for the at least one effect performance identifier in the identifier display region, display the effect performance identifier, which is added, in the component editing region of the component editing interface; and
in response to a component generation request, generate the effect processing component based on effect processing resource corresponding to the effect performance identifier.

19. A non-transitory computer-readable storage medium storing instructions that cause at least a processor to:
obtain effect input information and a target effect file in response to an effect processing request entered on a client, wherein the target effect file comprises at least one effect processing component and a component scheduling file, the component scheduling file comprises a component scheduling logic for scheduling the effect processing component; and
process the effect input information by the component scheduling file and the effect processing component, to obtain target effect information corresponding to the effect input information, and display the target effect information on the client.

20. The non-transitory computer-readable storage medium according to claim 19, wherein the component scheduling logic comprises component input information and a component output effect of the effect processing component; and when processing the effect input information by the component scheduling file and the effect processing component to obtain the target effect information corresponding to the effect input information, the processor is caused to:
schedule the effect input information, the effect processing component, and the component input information and the component output effect of the effect processing component, according to the component scheduling logic by the component scheduling file, to obtain the target effect information corresponding to the effect input information.
